(19) United States
(12) Patent Application Publication
(10) Pub. No.: US 2024/0127261 A1
(43) Pub. Date: Apr. 18, 2024

(54) LOAD PROFILE BASED REMOVAL OF GREENHOUSE EMISSIONS

(71) Applicant: Honda Motor Co., Ltd., Tokyo (JP)

(72) Inventor: ROBERT UYEKI, Torrance, CA (US)

(21) Appl. No.: 17/966,624

(22) Filed: Oct. 14, 2022

(51) Int. Cl. G06Q 30/00; G06Q 50/06

(52) U.S. Cl. CPC G06Q 30/018; G06Q 50/06

(57) ABSTRACT

A system and method for load profile based removal of greenhouse emissions is provided. The system receives a first load profile associated with a factory. The system receives a second load profile associated with a power plant, wherein the power plant is communicably coupled with the factory and a greenhouse emission capturing device. The system controls the greenhouse emission capturing device to remove greenhouse emissions from a region surrounding the greenhouse emission capturing device, based on the received first load profile associated with the factory and the second load profile associated with the power plant.

### BACKGROUND

Advancements in electronics and computing technology have led to development of a number of factories such as, a vehicle manufacturing factory. Such factories may emit a number of greenhouse gases while manufacture of products. Further, some of the greenhouse gases may be a result of electricity provided by a non-renewable energy power plant that may supply power to the factory. For example, a coal power plant that may provide electricity to the factory may emit greenhouse gases near the power plant. Such emission of greenhouse gases from the factories and the non-renewable energy power plants may eventually lead to climate change.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An exemplary aspect of the disclosure provides a system. The system may include a control circuitry. The control circuitry may receive a first load profile associated with a factory. The control circuitry may receive a second load profile associated with a power plant, wherein the power plant is communicably coupled with the factory and a greenhouse emission capturing device. The control circuitry may control the greenhouse emission capturing device to remove greenhouse emissions from a region surrounding the greenhouse emission capturing device, based on the received first load profile associated with the factory and the second load profile associated with the power plant.

Another exemplary aspect of the disclosure provides a method. The method may include reception of a first load profile associated with a factory. The method may further include reception of a second load profile associated with a power plant, wherein the power plant may be communicably coupled with the factory and a greenhouse emission capturing device. The method may further include controlling the greenhouse emission capturing device to remove greenhouse emissions from a region surrounding the greenhouse emission capturing device, based on the received first load profile associated with the factory and the second load profile associated with the power plant.

Another exemplary aspect of the disclosure provides a non-transitory computer-readable medium having stored thereon, computer-executable instructions. The computer-executable instructions that when executed by a system may cause the system to execute operations. The operations may include reception of a first load profile associated with a factory. The operations may further include reception of a second load profile associated with a power plant, wherein the power plant may be communicably coupled with the factory and a greenhouse emission capturing device. The operations may further include controlling the greenhouse emission capturing device to remove greenhouse emissions from a region surrounding the greenhouse emission capturing device, based on the received first load profile associated with the factory and the second load profile associated with the power plant.

### BRIEF DESCRIPTION OF THE DRAWINGS

FIG. 1 is a diagram that illustrates an exemplary network environment for load profile based removal of greenhouse emissions, in accordance with an embodiment of the disclosure.

FIG. 2 illustrates a block diagram of an exemplary system of FIG. 1, in accordance with an embodiment of the disclosure.

FIG. 3 is a diagram that illustrates an exemplary processing pipeline for load profile based removal of greenhouse emissions, in accordance with an embodiment of the disclosure.

FIG. 4 is a diagram that illustrates production schedule of a factory, in accordance with an embodiment of the disclosure.

FIG. 5 illustrates a flowchart of an exemplary method for load profile based removal of greenhouse emissions, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a disclosed system and method of load profile based removal of greenhouse emissions. Exemplary aspects of the disclosure provide a system that includes control circuitry that may receive a first load profile associated with a factory. The control circuitry may receive a second load profile associated with a power plant, wherein the power plant is communicably coupled with the factory and a greenhouse emission capturing device. The control circuitry may further control the greenhouse emission capturing device to remove greenhouse emissions from a region surrounding the greenhouse emission capturing device, based on the received first load profile associated with the factory and the second load profile associated with the power plant.

Typically, factories may emit a number of greenhouse gases (such as, carbon dioxide, methane, nitrous oxide, and the like) while manufacture of products. Further, some of the greenhouse gases may be generated as a result of electricity provided by a power plant that may supply power to the factory. For example, a coal power plant may provide electricity to the factory. The generation of the electricity for the factory may result a release of carbon and other greenhouse gases near the power plant. In some scenarios, the power plant and the factory may not be in close proximity to each other and the electricity may be transported over many miles. Such emission of greenhouse gases from the power plant and also from the factories may eventually lead to global-warming and climate change.

The disclosed system may allow the factory to work in tandem with the power plant to reduce overall greenhouse emissions by use of a greenhouse emission capturing device. Herein, the factory may communicate with the power plant and/or the greenhouse emission capturing device. Based on an early coordination of the greenhouse emission capturing device with the factory and the power plant, the greenhouse emission capturing device may schedule removal of the greenhouse emissions from a region surrounding the greenhouse emission capturing device. Based on the generation of electricity by the power plant, large amounts of greenhouse emissions may be emitted. The greenhouse emission capturing device may be operated in advance in such a way that the greenhouse emissions output from power plant may be removed effectively, based on a load profile (e.g., an estimated power demand) of the power plant. Similarly, the greenhouse emission capturing device may be operated based on a load profile (e.g., an estimated power consumption) of the factory to increase efficiency of removal of the greenhouse emissions at the time of operation of the factory. Thus, the greenhouse emission capturing device may work to absorb the greenhouse emissions both from the factory and the power plant to achieve a net zero greenhouse emission, over a certain period of time, such as, a 24-hours period.

Reference will now be made in detail to specific aspects or features, examples of which are illustrated in the accompanying drawings. Wherever possible, corresponding, or similar reference numbers will be used throughout the drawings to refer to the same or corresponding parts.

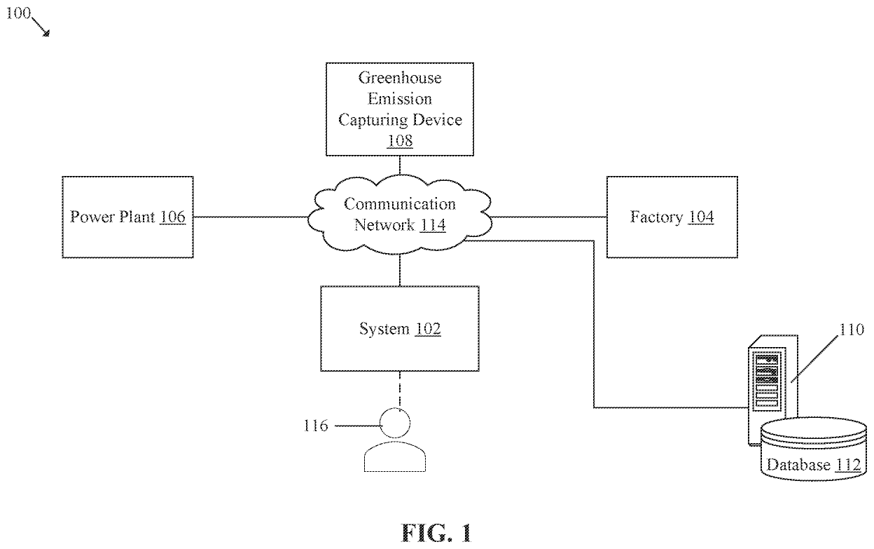

FIG. 1 is a diagram that illustrates an exemplary network environment for load profile based removal of greenhouse emissions, in accordance with an embodiment of the disclosure. With reference to FIG. 1, there is shown an exemplary network environment 100. In the exemplary network environment 100, there is shown a system 102, a factory 104, a power plant 106, a greenhouse emission capturing device 108, a server 110, and a database 112. The system 102 and the server 110 may be communicatively coupled to each other via a communication network 114. The system 102 may be further communicatively coupled to the factory 104, the power plant 106, and the greenhouse emission capturing device 108. In an embodiment, the power plant 106 may be communicatively coupled with the factory 104 and the greenhouse emission capturing device 108, via a communication medium (such as, the communication network 114) and/or the system 102. In FIG. 1, there is further shown a user 116 who may be associated with or operate the system 102. In certain cases, the user 116 may correspond to an employee or a manager of the factory 104.

The system 102 may include suitable logic, circuitry, and interfaces that may be configured to receive a first load profile associated with a factory (e.g., the factory 104). In an embodiment, the system 102 may receive the first load profile from the server 110. Further, the system 102 may be configured to receive a second load profile associated with a power plant (e.g., the power plant 106) from the server 110. The system 102 may be configured to control the greenhouse emission capturing device 108 to remove greenhouse emissions from a region surrounding the greenhouse emission capturing device, based on the received first load profile and the received second load profile. Examples of the system 102 may include, but are not limited to, an environmental control engine, a computing device, a smartphone, a cellular phone, a mobile phone, a gaming device, a mainframe machine, a server, a computer work-station, and/or a consumer electronic (CE) device. In an embodiment, the system 102 may correspond to a computing device associated with the factory 104 or a computing device associated with the power plant 106.

The factory 104 may include a group of buildings comprising machines that may manufacture goods/products in large quantities. In an embodiment, the factory 104 may include one or more assembly lines associated with the machines to manufacture the goods/products. For example, a vehicle manufacturing factory may manufacture vehicles. Similarly, an air conditioner manufacturing factory may manufacture air conditioners. The factory 104 may need power for operation, that may be supplied by the power plant 106. The factory 104 may include a computing device (not shown) that may receive information associated with tasks scheduled in the factory 104 and/or the first load profile associated with the factory 104. For example, the information associated with the tasks and/or the first load profile may be received as a user input from a user associated with the factory 104, such as, an employee or manager of the factory 104. The computing device of the factory 104 may transmit the information associated with the tasks scheduled in the factory 104 and/or the first load profile to the server 110 for storage or to the system 102.

The power plant 106 may be an electric utility generation station that may generate electric power. For example, the power plant 106 may be a fossil fuel power plant, a hydroelectric power plant, a solar thermal power plant, a nuclear power plant, a geothermal power plant, or wind power towers. The power plant 106 may provide power to the factory 104 and to the greenhouse emission capturing device 108. The power plant 106 may include a computing device that may receive information associated with the second load profile as a user input from an employee or a manager of the power plant 106. The computing device of the power plant 106 may transmit the information associated with the second load profile to the server 110 for storage or to the system 102.

The greenhouse emission capturing device 108 may capture greenhouse gases such as, carbon dioxide, in a surrounding air. The greenhouse emission capturing device 108 may capture the greenhouse gases emitted from the factory 104 and the power plant 106 in order to mitigate the effect of greenhouse emissions on climate change. The greenhouse emission capturing device 108 may be in communication with the factory 104 and/or the power plant 106. Further, reductions in carbon through the greenhouse emission capturing device 108 may not have to be performed at the same time as carbon is produced, rather the carbon capturing may occur over a time period such as, twenty four hours, based on when the greenhouse emission capturing device 108 is activated for emission removal. For example, the greenhouse emission capturing device 108 may include, but is not limited to, an oxyfuel combustion based emission capture device or a carbon dioxide scrubber device.

The server 110 may include suitable logic, circuitry, and interfaces, and/or code that may be configured to receive the first load profile associated with the factory 104 and the second load profile associated with the power plant 106. The server 110 may control the greenhouse emission capturing device 108 to remove greenhouse emissions from a region surrounding the greenhouse emission capturing device 108, based on the received first load profile associated with the factory 104 and the second load profile associated with the power plant 106. The server 110 may be implemented as a cloud server and may execute operations through web applications, cloud applications, HTTP requests, repository operations, file transfer, and the like. Other example implementations of the server 110 may include, but are not limited to, a database server, a file server, a web server, a media server, an application server, a mainframe server, or a cloud computing server.

In at least one embodiment, the server 110 may be implemented as a plurality of distributed cloud-based resources by use of several technologies that are well known to those ordinarily skilled in the art. A person with ordinary skill in the art will understand that the scope of the disclosure may not be limited to the implementation of the server 110 and the system 102 as two separate entities. In certain embodiments, the functionalities of the server 110 can be incorporated in its entirety or at least partially in the system 102, without a departure from the scope of the disclosure.

The database 112 may include suitable logic, interfaces, and/or code that may be configured to store the first load profile and/or the second load profile. The database 112 may be derived from data off a relational or non-relational database. The database 112 may be stored or cached on a device, such as a server (such as, the server 110) or the system 102. The device that stores the database 112 may be configured to receive a query for the first load profile and/or the second load profile from the system 102 and/or the server 110. In response, the device of the database 112 may be configured to retrieve and provide the queried the first load profile and/or the second load profile to the system 102 and/or the server 110, based on the received query.

In some embodiments, the database 112 may be hosted on a plurality of servers stored at same or different locations. The operations of the database 112 may be executed using hardware including a processor, a microprocessor (e.g., to perform or control performance of one or more operations), a field-programmable gate array (FPGA), or an application-specific integrated circuit (ASIC). In some other instances, the database 112 may be implemented using software.

The communication network 114 may include a communication medium through which the system 102, the factory 104, the power plant 106, the greenhouse emission capturing device 108, and the server 110 may communicate with each other. The communication network 114 may be one of a wired connection or a wireless connection Examples of the communication network 114 may include, but are not limited to, the Internet, a cloud network, Cellular or Wireless Mobile Network (such as Long-Term Evolution and 5G New Radio), a satellite network (for example, a network formed by use of a set of low-earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 114 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

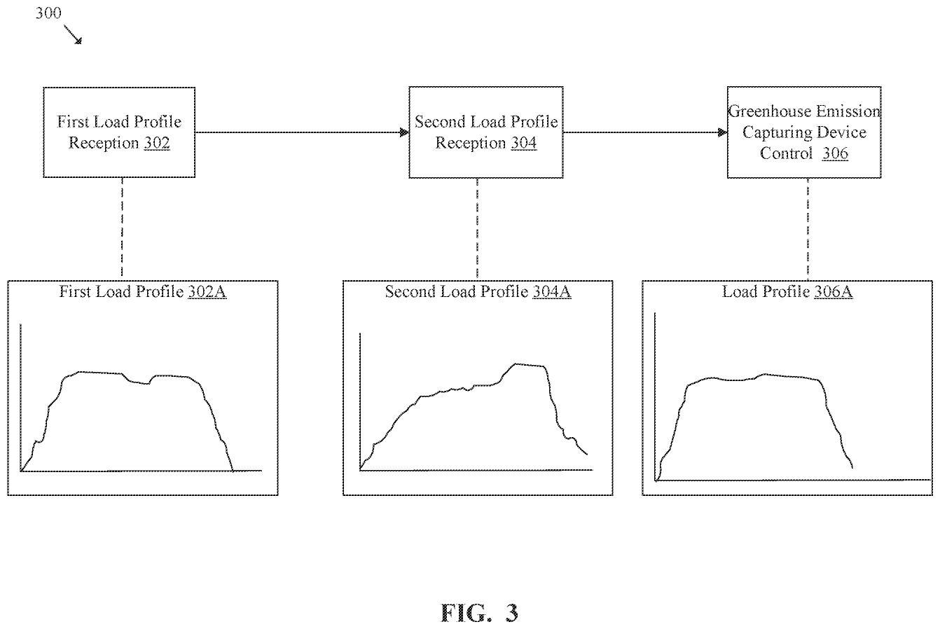

In operation, the system 102 receive the first load profile associated with the factory 104. It may be appreciated that the factory 104 may need power for operation, which may be indicated by the first load profile. It may be noted that the factory 104 may emit greenhouse gases in a surrounding of the factory 104, when the factory 104 is operated. The first load profile may also give information related to amount of greenhouse gases the factory 104 may emit when performing certain task. In an example, the first load profile associated with the factory 104 may include information indicative of at least one of, but not limited to, an amount of power required by the factory 104, an amount of predicted greenhouse emission during an operation of the factory 104, or a first time period for which the power is required. Details about the first load profile are described, for example, in FIG. 3 (at 302).

The system 102 may receive the second load profile associated with the power plant 106, wherein the power plant 106 may be communicably coupled with the factory 104 and the greenhouse emission capturing device 108. The power plant 106 may generate certain amount of power based on the amount of power that the power plant 106 may need to supply to the factory 104 and the greenhouse emission capturing device 108. The amount of power to be generated by the power plant 106 may be indicated by the second load profile. Further, the power plant 106 may also emit greenhouse gases in a surrounding of the power plant 106, when the power plant 106 is operated. The second load profile may thus provide profile information related to the amount of predicted greenhouse emission that the power plant 106 may emit during the operation of the power plant 106. In an example, the second load profile associated with the power plant 106 may include information indicative of at least one of, but not limited to, an amount of power to be generated by the power plant 106, an amount of predicted greenhouse emission during an operation of the power plant 106, or a second time period for which the power is to be generated. Details about the second load profile are described, for example, in FIG. 3 (at 304).

The system 102 may control the greenhouse emission capturing device 108 to remove greenhouse emissions from a region surrounding the greenhouse emission capturing device 108, based on the received first load profile associated with the factory 104 and the second load profile associated with the power plant 106. Based on the received first load profile associated with the factory 104 and the second load profile associated with the power plant 106, the system 102 may determine a net amount of greenhouse emissions to be removed from the region surrounding the greenhouse emission capturing device 108. The greenhouse emission capturing device 108 may remove an amount of greenhouse emissions from the region surrounding the greenhouse emission capturing device 108 in advance, i.e., prior to the generation of the emissions such that a net zero carbon footprint is achieved. Details about the removal of the greenhouse emissions are described, for example, in FIG. 3 (at 306).

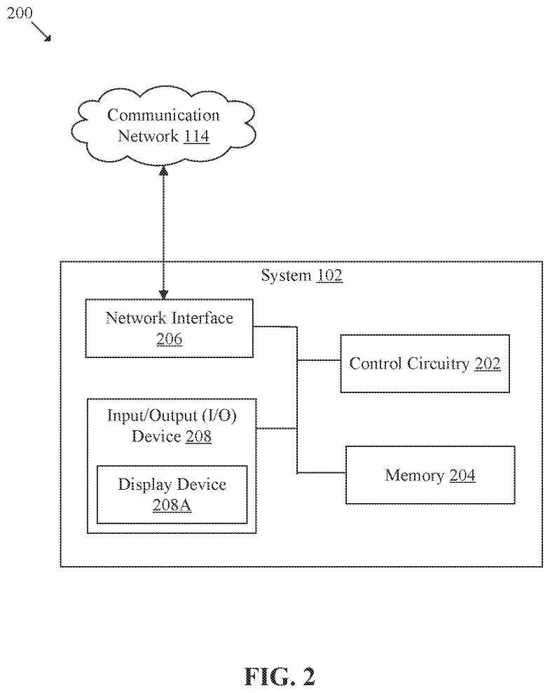

FIG. 2 is a block diagram of an exemplary communication device of FIG. 1, in accordance with an embodiment of the disclosure. FIG. 2 is explained in conjunction with elements from FIG. 1. With reference to FIG. 2, there is shown a block diagram 200 of the system 102. The system 102 may include control circuitry 202, a memory 204, a network interface 206, and an input/output (I/O) device 208 comprising a display device 208A. Although in FIG. 2, it is shown that the system 102 includes the control circuitry 202, the memory 204, the network interface 206, and the input/output (I/O) device 208; however, the disclosure may not be so limiting, and the system 102 may include less or more components to perform the same or other functions of the system 102. Details of the other functions or components have been omitted from the disclosure for the sake of brevity.

The control circuitry 202 may include suitable logic, circuitry, and interfaces that may be configured to execute program instructions associated with different operations. For example, the operations may include, but are not limited to, an operation for first load profile reception, an operation for second load profile reception, and an operation for greenhouse emission capturing device control. The control circuitry 202 may include one or more specialized processing units, which may be implemented as a separate processor. In an embodiment, the one or more specialized processing units may be implemented as an integrated processor or a cluster of processors that perform the functions of the one or more specialized processing units, collectively. The control circuitry 202 may be implemented based on a number of processor technologies known in the art. Examples of implementations of the control circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, and interfaces that may be configured to store the one or more instructions to be executed by the control circuitry 202. The one or more stored instructions may be executable by the control circuitry 202 to perform the operations of the control circuitry 202 (or the system 102). The memory 204 that may be configured to store the first load profile and the second load profile. The memory 204 may be a persistent storage medium, a non-persistent storage medium, or a combination thereof. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may include suitable logic, circuitry, and interfaces that may be configured to facilitate communication between the control circuitry 202, computing devices of the power plant 106 and the factory 104, the greenhouse emission capturing device 108, and the server 110, via the communication network 114. The network interface 206 may be implemented by use of various known technologies to support wired or wireless communication of the system 102 with the communication network 114. The network interface 206 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 206 may be configured to communicate via wireless communication with networks, such as the Internet, an Intranet, or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The input/output (I/O) device 208 may include suitable logic, circuitry, and interfaces that may be configured to receive an input from the user (such as, the user 116) and provide an output based on the received input. For example, the I/O device 208 may receive a user input indicative of the first load profile and/or the second load profile. The I/O device 208 may display information associated with the first load profile and/or the second load profile. Further, the I/O device 208 may display information associated with the control of the greenhouse emission capturing device 108. The I/O device 208 which may include various input and output devices, may be configured to communicate with the control circuitry 202. Examples of the I/O device 208 may include, but are not limited to, a touch screen, a keyboard, a mouse, a joystick, a microphone, a display device (such as, the display device 208A), and a speaker.

The display device 208A may include suitable logic, circuitry, and interfaces that may be configured to display the first load profile and the second load profile. The display device 208A may be further configured to display information associated with the control of the greenhouse emission capturing device 108 and/or information associated with an amount of gases removed over a period of time. The display device 208A may be a touch screen which may enable a user to provide a user-input via the display device 208A. The touch screen may be at least one of a resistive touch screen, a capacitive touch screen, or a thermal touch screen. The display device 208A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 208A may refer to a display screen of the smartphone, the computer workstation, the handheld computer, the cellular/mobile phone, the portable consumer electronic (CE) device, a smart-glass device, a see-through display, a projection-based display, an electro-chromic display, or a transparent display.

The functions or operations executed by the system 102, as described in FIG. 1, may be performed by the control circuitry 202. Operations executed by the control circuitry 202 are described in detail, for example, in FIG. 3.

FIG. 3 is a diagram that illustrates an exemplary processing pipeline for load profile based removal of greenhouse emissions, in accordance with an embodiment of the disclosure. FIG. 3 is explained in conjunction with elements from FIG. 1 and FIG. 2. With reference to FIG. 3, there is shown an exemplary processing pipeline 300 that illustrates exemplary operations from 302 to 306 for load profile based removal of greenhouse emissions. The exemplary operations 302 to 306 may be executed by any computing system, for example, by the system 102 of FIG. 1 or by the control circuitry 202 of FIG. 2. The exemplary processing pipeline 300 further illustrates a first load profile 302A, a second load profile 304A, a load profile 306A. The first load profile 302A may be associated with the factory 104, the second load profile 304A may be associated with the power plant 106, and the load profile 306A may be associated with the greenhouse emission capturing device 108.

At 302, an operation for a first load profile reception may be executed. The control circuitry 202 may be configured to receive the first load profile 302A associated with the factory 104. It may be appreciated that the factory 104 may need power for operation. An amount of power needed by the factory 104 may depend on goods/products manufactured by the factory 104 and a time duration for which the factory 104 is operated, which may be indicated by the first load profile 302A. It may be noted that the factory 104 may emit greenhouse gases in a surrounding of the factory 104, when the factory 104 is operated. The first load profile 302A may also give information related to amount of greenhouse gases that the factory 104 may emit when a certain task is performed.

In an embodiment, the first load profile 302A associated with the factory 104 may include information indicative of at least one of, but not limited to, an amount of power required by the factory 104, an amount of predicted greenhouse emission during an operation of the factory 104, or a first time period for which the power may be required. The amount of power required by the factory 104 may be the amount of power required to perform a set of operations associated with the factory 104. The amount of power may be received by the factory 104 from the power plant 106. For example, if the factory 104 is a vehicle manufacturing plant, then the first load profile 302A associated with the factory 104 may correspond to an amount of power required by the factory 104 to manufacture or assemble, for example, hundred cars in a period of time. It may be noted that the factory 104 may emit greenhouse gases such as, carbon dioxide during an operation of the factory 104. For example, to manufacture hundred cars, the factory 104 may emit a certain amount of carbon dioxide. The amount of greenhouse gases emitted by the factory 104 during its operation such as, during manufacture of hundred cars, may be predicted in advance. The amount of predicted greenhouse emission during the operation of the factory 104 may be also taken as the first load profile 302A. It may be further noted that the factory 104 may not need power throughout the operation of the factory 104. For example, the factory 104 may need power only when the factory 104 is scheduled to manufacture goods. Thus, the first load profile 302A associated with the factory 104 may also include information indicative of a first time period for which the power may be required. An example of such information included in the first load profile 302A (of FIG. 3) associated with the factory 104 is shown as a time-series graph of the amount of power received by the power plant 106 at various time instants during a day or for an extended period of time (such as, a week).

At 304, an operation for a second load profile reception may be executed. The control circuitry 202 may be configured to receive the second load profile 304A associated with the power plant 106, wherein the power plant 106 may be communicably coupled with the factory 104 and the greenhouse emission capturing device 108. The power plant 106 may generate certain amount of power based on an amount of power that the power plant 106 may need to supply to the factory 104 and also to the greenhouse emission capturing device 108. The amount of power that may be required to be generated by the power plant 106 may be indicated by the second load profile 304A. The power plant 106 may also emit greenhouse gases in a region surrounding the power plant 106, when the power plant 106 may be in operation. The second load profile 304A may thus further include information related to an amount of predicted greenhouse gas emission that the power plant 106 may emit during the operation of the power plant 106.

In an embodiment, the second load profile 304A associated with the power plant 106 may include information indicative of at least one of, but not limited to, an amount of power to be generated by the power plant 106, an amount of predicted greenhouse emission during an operation of the power plant 106, or a second time period for which the power is to be generated. The amount of power to be generated by the power plant 106 may depend on a power demand (for example, an amount of power that the power plant 106 may need to supply to the factory 104 and the greenhouse emission capturing device 108). The computing device (not shown) of the power plant 106 may communicate with computing device (not shown) of the factory 104 and the greenhouse emission capturing device 108 to determine the amount of power to be generated by the power plant 106. Thus, the second load profile 304A associated with the power plant 106 may be determined based on the first load profile 302A associated with the factory 104 and a load profile (such as, the load profile 306A) associated with the greenhouse emission capturing device 108. It may be noted that the power plant 106 may emit greenhouse gases, such as, carbon dioxide, during an operation of the power plant 106. For example, upon generation of a thousand kilowatts of power, the power plant 106 may emit a certain amount of carbon dioxide. The amount of greenhouse gases emitted by the power plant 106 during its operation may be predicted in advance. The amount of predicted greenhouse emission that may be generated during the operation of the power plant 106 may correspond to the second load profile 304A. It may be further noted that the power plant 106 may not generate power throughout a time period of an operation of the power plant 106. For example, the power plant 106 may generate power for say, six hours, in order to provide power to the factory 104. Thus, the second load profile 304A associated with the power plant 106 may also include a second time period for which the power may be generated by the power plant 106. An example of information included in the second load profile 304A (of FIG. 3) associated with the power plant 106 is shown as a time-series graph of the amount of power generated the power plant 106 at various time instants during a day or for an extended period of time (such as, a week).

At 306, an operation for control of a greenhouse emission capturing device may be executed. The control circuitry 202 may be configured to control the greenhouse emission capturing device 108 to remove greenhouse emissions from a region surrounding the greenhouse emission capturing device 108 based on the received first load profile 302A associated with the factory 104 and the second load profile 304A associated with the power plant 106. Based on the received first load profile 302A associated with the factory 104 and the second load profile 304A associated with the power plant 106, the control circuitry 202 may determine the amount of greenhouse emissions to be removed from the region surrounding the greenhouse emission capturing device 108. For example, if the factory 104 may be predicted to emit ‘X’ amount of greenhouse emissions and the power plant 106 may be predicted to emit ‘Y’ amount of greenhouse emissions then the greenhouse emission capturing device 108 may be required to remove addition of ‘X’ and ‘Y’ (i.e., X+Y) amount of greenhouse emissions from the region surrounding the greenhouse emission capturing device 108 in advance to achieve a net zero carbon footprint for the operation of the factory 104 and the power plant 106 for a certain time period (e.g., 24 hours).

In an embodiment, the control circuitry 202 may determine the load profile 306A associated with the greenhouse emission capturing device 108 based on the received first load profile 302A associated with the factory 104 and the second load profile 304A associated with the power plant 106. In an embodiment, the load profile 306A associated with the greenhouse emission capturing device 108 may include information indicative of at least one of, but not limited to, an amount of power required by the greenhouse emission capturing device 108, an amount of predicted greenhouse emission during an operation of the greenhouse emission capturing device 108, or a time period for which the power is to be generated. The amount of power required by the greenhouse emission capturing device 108 may be the amount of power required to execute a set of operations needed for removal of the greenhouse emission associated with the greenhouse emission capturing device 108. The amount of power may be received by the greenhouse emission capturing device 108 from the power plant 106. It may be noted that the greenhouse emission capturing device 108 may also emit greenhouse gases such as, carbon dioxide, during its operation. The amount of greenhouse gases emitted by the greenhouse emission capturing device 108 during its operation may be predicted in advance. The amount of predicted greenhouse emission due to the operation of the greenhouse emission capturing device 108 may be also taken into consideration for greenhouse emission removal. The amount of predicted greenhouse emission associated with the operation of the greenhouse emission capturing device 108 may correspond to the load profile 306A. It may be further noted that the greenhouse emission capturing device 108 may not need power throughout an operation of the greenhouse emission capturing device 108. For example, the greenhouse emission capturing device 108 may need power only when the greenhouse emission capturing device 108 is scheduled to capture the greenhouse gases. Thus, the load profile 306A associated with the greenhouse emission capturing device 108 may include a time period for which the power may be required for operation of the greenhouse emission capturing device 108. The load profile 306A (of FIG. 3) associated with the greenhouse emission capturing device 108 is shown as a time-series graph of the amount of power received by the greenhouse emission capturing device 108 at various time instants during a day or for an extended period of time (such as, a week).

It may be noted that to make the factory 104 into a carbon-neutral factory, the time that the greenhouse emission capturing device 108 may be run may also be required to be considered. For example, if the factory 104 requires 100 MW of energy, the greenhouse emission capturing device 108 may not have to be run immediately. Rather, the control circuitry 202 may determine a time period that the greenhouse emission capturing device 108 may be required to run in order to mitigate or absorb the greenhouse emissions that may be produced due to the generation and/or consumption of the 100 MW of energy. In an example, the greenhouse emission capturing device 108 may be run a couple of hours before any electricity may be requested by the factory 104.

In an example, a staggered approach for operation of the greenhouse emission capturing device 108 may be employed. It may be noted that, if the greenhouse emission capturing device 108 is running while the power plant 106 generates energy, then the greenhouse emission capturing device 108 may be needed to be run for a lesser duration or with a lesser capacity. Therefore, it may be more effective to run the greenhouse emission capturing device 108 when the power plant 106 generates the greenhouse emission. If the greenhouse emission capturing device 108 is non-operational or runs at a reduced capacity, then a difference between a removal of the greenhouse emissions may be performed at some other time with a requirement of an additional time for compensation of the reduced capacity. Thus, closer is an execution time of the greenhouse emission capturing device 108 to a time of generation of the greenhouse emission, a lesser may be a duration for which the greenhouse emission capturing device 108 may have to be run. The greenhouse emission capturing device 108 may provide a net zero carbon output, which may be spread out over a period of twenty-four hours.

In an embodiment, the greenhouse emission capturing device 108 may be located within a first predefined distance from each of the factory 104 and the power plant 106, and the factory 104 may be located within a second predefined distance from the power plant 106. In some cases, the greenhouse emission capturing device 108 may be closer to the factory 104.

In an embodiment, the control circuitry 202 may be further configured to determine a third time period for which the greenhouse emission capturing device 108 may be operated to remove the greenhouse emissions in the region surrounding the greenhouse emission capturing device 108, based on the received first load profile 302A associated with the factory 104 and the received second load profile 304A associated with the power plant 106. As discussed, the amount of greenhouse emissions to be removed in the region surrounding the greenhouse emission capturing device 108 may be determined based on the received first load profile 302A associated with the factory 104 and the received second load profile 304A associated with the power plant 106. In order to remove the amount of the of greenhouse emissions, the greenhouse emission capturing device 108 may need to be operated for the third time period. In some embodiments, the greenhouse emission capturing device 108 may have different modes of operations based on a rate of removal (e.g., in metric tons) of the greenhouse emissions from the region. In such cases, the determined third time period may further to depend on the mode of operation (e.g., a certain metric tons of emission removal rate) of the greenhouse emission capturing device 108.

In an embodiment, the control circuitry 202 may be further configured to determine a schedule for an operation of the greenhouse emission capturing device 108 based on the determined third time period, wherein the control of the greenhouse emission capturing device 108 may be further based on the determined schedule. As discussed, the determined third time period may be a time period for which the greenhouse emission capturing device 108 may be operated to remove the greenhouse emissions in the region surrounding the greenhouse emission capturing device 108. Based on the determined third time period, the control circuitry 202 may determine the schedule for an operation of the greenhouse emission capturing device 108. The greenhouse emission capturing device 108 may be operated in the schedule to remove the greenhouse emissions in the region. In an example, the determined third time period may be ‘6’ hours and the greenhouse emission capturing device 108 may be scheduled for operation during ‘1200 hours’ to ‘1800 hours’ (i.e., between 12 noon and 6:00 PM).

In an embodiment, the control circuitry 202 may be further configured to determine a fourth time period for which the greenhouse emission capturing device 108 may be required to be kept under maintenance, wherein the third time period may be determined further based on the fourth time period. It may be appreciated that the greenhouse emission capturing device 108 may require cleaning (e.g., a cleaning of filters and other emission removal apparatuses) and may have a downtime for maintenance. During periods such as the fourth time period, a minimal usage of the greenhouse emission capturing device 108 may be enabled. The greenhouse emission capturing device 108 may not remove the greenhouse emissions from the region during the fourth time period effectively. Thus, the control circuitry 202 may determine the schedule for operation of the greenhouse emission capturing device 108 based on the fourth time period. In an example, the determined third time period may be ‘6’ hours, the fourth time period may ‘1200 hours’ to ‘1500 hours’ and the greenhouse emission capturing device 108 may be scheduled for operation during ‘1500 hours’ to ‘2100 hours’. The factory 104 may emit greenhouse emission and work with the greenhouse emission capturing device 108 at certain defined times.

In other words, the system 102 may fit the schedule of the factory 104 to the schedule of the greenhouse emission capturing device 108. The control circuitry 202 may receive information related to an operation of the factory 104, from a computing device (not shown) associated with the factory 104. Further, the control circuitry 202 may receive information related to an operation and maintenance of the greenhouse emission capturing device 108, from a computing device (not shown) associated with the greenhouse emission capturing device 108. The control circuitry 202 may compare a time period associated with the task schedule and operation of the factory 104 with a time period associated with the operation and maintenance of the greenhouse emission capturing device 108. Based on the comparison, the control circuitry 202 may determine an overlapping operational time period for the factory 104 and the greenhouse emission capturing device 108. During the overlapping operational time period, a net greenhouse emissions generated by the factory 104 may be neutralized by the greenhouse emission capturing device 108.

In an embodiment, the control circuitry 202 may be further configured to receive a task schedule associated with the factory 104, wherein the control of the greenhouse emission capturing device 108 may be further based on the received task schedule. Herein, the task schedule may be time stamps at which the factory 104 may be operated to manufacture goods/products. For example, the task schedule may include manufacture of ‘ten’ vehicles from ‘0700 hours’ to ‘0800 hours’ and manufacture of ‘25’ vehicles from ‘1000 hours’ to ‘1300 hours’ on a certain day. The greenhouse emission capturing device 108 may be controlled to remove the greenhouse emissions based on such task schedule of the factory 104.

Typically, factories may emit a number of greenhouse gases (such as, carbon dioxide, methane, nitrous oxide, and the like) while manufacture of products. Further, some of the greenhouse gases may be generated as a result of electricity provided by a power plant that may supply power to the factory. For example, a coal power plant may provide electricity to the factory. The generation of the electricity for the factory may result a release of carbon and other greenhouse gases near the power plant. In some scenarios, the power plant and the factory may not be in close proximity to each other and the electricity may be transported over many miles. Such emission of greenhouse gases from the power plant and also from the factories may eventually lead to global-warming and climate change.

The disclosed system 102 may allow the factory 104 to work in tandem with the power plant 106 to reduce overall greenhouse emissions by use of the greenhouse emission capturing device 108. Herein, communication devices of the factory 104 may communicate with communication devices of the power plant 106 and/or the greenhouse emission capturing device 108. Based on an early coordination of the greenhouse emission capturing device 108 with the factory 104 and the power plant 106, the greenhouse emission capturing device 108 may schedule the removal of the greenhouse emissions from a region surrounding the greenhouse emission capturing device 108. Based on the generation of electricity by the power plant 106, large amounts of greenhouse emissions may be emitted. The greenhouse emission capturing device 108 may be operated in advance in such a way that the greenhouse emissions output from power plant 106 may be removed effectively, based on a load profile (e.g., the second load profile 304A, i.e., an estimated power demand) of the power plant 106. Similarly, the greenhouse emission capturing device 108 may be operated based on a load profile (e.g., the first load profile 302A, i.e., an estimated power consumption) of the factory 104 to increase efficiency of removal of the greenhouse emissions at the time of operation of the factory 104. Thus, the greenhouse emission capturing device 108 may work (or controlled) to absorb the greenhouse emissions both from the factory 104 and the power plant 106 to achieve a net zero greenhouse emission, over a certain period of time, such as, a 24-hours period.

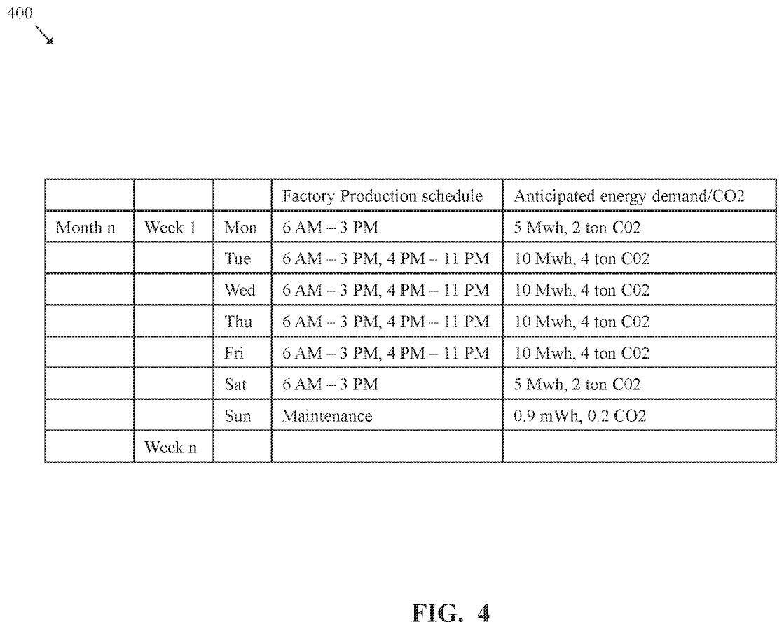

FIG. 4 is a diagram that illustrates an exemplary production schedule of a factory, in accordance with an embodiment of the disclosure. FIG. 4 is explained in conjunction with elements from FIG. 1, FIG. 2, and FIG. 3. With reference to FIG. 4, there is shown an exemplary table 400, that illustrates a production schedule of the factory such as, the factory 104 of FIG. 1.

With reference to FIG. 4, the table 400 includes exemplary information associated with a production schedule of a certain week (e.g., a week 1) of a certain month (e.g., a month n) for the factory 104. According to the production schedule in the table 400, on Monday of the week 1, the factory 104 may operate between ‘6 AM’ to ‘3 PM’. The amount of energy that may be needed by the factory 104 for operation between ‘6 AM’ to ‘3 PM’ may be ‘5 Mwh’. The factory 104 may emit ‘2 ton’ of carbon dioxide when it operates between ‘6 AM’ to ‘3 PM’. Further, as shown in FIG. 4, the production schedule on Tuesday of the week 1 may be ‘6 AM’ to ‘3 PM’ and ‘4 PM’ and ‘11 PM’. The amount of energy needed by the factory 104 for operation between ‘6 AM’ to ‘3 PM’ and ‘4 PM’ and ‘11 PM’ on Tuesday of the week 1 may be ‘10 Mwh’. The factory 104 may emit ‘4 ton’ of carbon dioxide when operation between ‘6 AM’ to ‘3 PM and ‘4 PM’ and ‘11 PM’ on Tuesday of the week 1. The production schedule on Wednesday of first week may be ‘6 AM’ to ‘3 PM’ and ‘4 PM’ and ‘11 PM’. The amount of energy needed by the factory 104 for operating between ‘6 AM’ to ‘3 PM’ and ‘4 PM’ and ‘11 PM’ on Wednesday of first week may be ‘10 Mwh’. Similarly, the production schedules of the factory 104 on other days of the week 1, such as, Wednesday, Thursday, Friday, and Saturday, are shown in the table 400 of FIG. 4. As shown in FIG. 4, on Sunday of the week 1, the factory 104 may be under maintenance and no production activity may be carried out on Sunday. However, there may be a certain greenhouse emission associated with the maintenance activity that may be performed on Sunday. For example, the factory 104 may consume ‘0.9 mWh’ of energy on Sunday during the maintenance activity and emit ‘0.2 tons’ of carbon dioxide in the process.

It should be noted that the table 400 including the production schedule of the factory 104, as shown in FIG. 4, is for exemplary purposes and should not be construed to limit the scope of the disclosure.

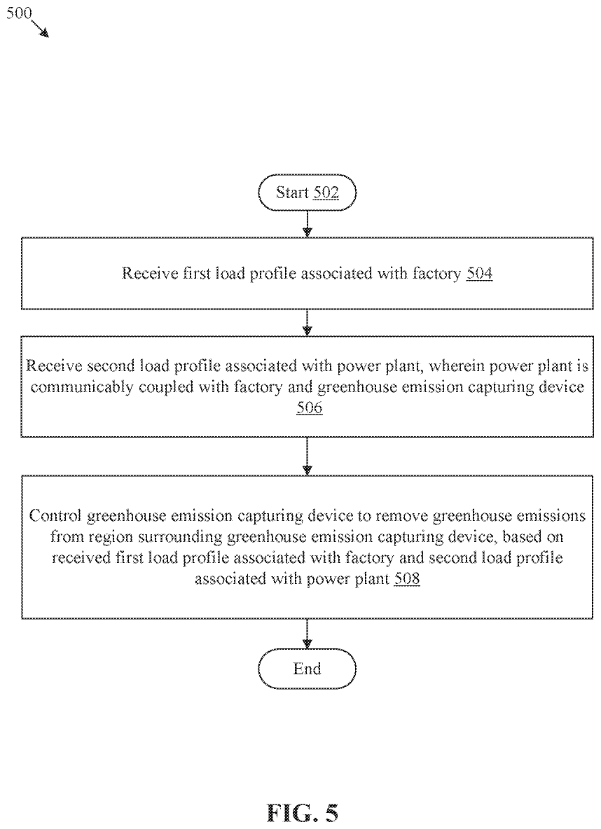

FIG. 5 illustrates a flowchart of an exemplary method for load profile based removal of greenhouse emissions, in accordance with an embodiment of the disclosure. With reference to FIG. 5, there is shown a flowchart 500. The flowchart 500 is described in conjunction with FIG. 1, FIG. 2, FIG. 3, and FIG. 4. The operations from 502 to 508 may be implemented, for example, by the system 102 of FIG. 1 or the control circuitry 202 of FIG. 2. The operations of the flowchart 500 may start at 502 and proceed to 504.

At 504, the first load profile (such as, the first load profile 302A of FIG. 3) associated with the factory 104 may be received. In accordance with an embodiment, the control circuitry 202 may be configured to receive the first load profile (such as, the first load profile 302A of FIG. 3) associated with the factory 104. It may be appreciated that the factory 104 may need power for operation, which may be indicated by the first load profile. It may be noted that the factory 104 may emit greenhouse gases in a region surrounding the factory 104, when the factory 104 may be operated. The first load profile 302A may also give information related to amount of greenhouse gases that the factory 104 may emit when a certain task may be performed. Details about the first load profile are described further, for example, in FIG. 3 (at 302).

At 506, the second load profile (such as, the second load profile 304A of FIG. 3) associated with the power plant 106 may be received, wherein the power plant 106 may be communicably coupled with the factory 104 and the greenhouse emission capturing device 108. The control circuitry 202 may be configured to receive the second load profile (such as, the second load profile 304A of FIG. 3) associated with the power plant 106. The power plant 106 may be communicably coupled with the factory 104 and the greenhouse emission capturing device 108. The power plant 106 may generate a certain amount of power, based on the amount of power that the power plant 106 may need to supply to the factory 104 and the greenhouse emission capturing device 108. The amount of power that may be required to be generated by the power plant 106 may be indicated by the second load profile 304A. Further, the power plant 106 may also emit greenhouse gases in a region surrounding the power plant 106, when the power plant 106 may be in operation. The second load profile 304A may thus further include profile information related to the amount of predicted greenhouse emission that the power plant 106 may emit during the operation of the power plant 106. Details about the second load profile are described further, for example, in FIG. 3 (at 304).

At 508, the greenhouse emission capturing device 108 may be controlled to remove greenhouse emissions from the region surrounding the greenhouse emission capturing device 108, based on the received first load profile (such as, the received first load profile 302A of FIG. 3) associated with the factory 104 and the second load profile (such as, the received second load profile 304A of FIG. 3) associated with the power plant 106. The control circuitry 202 may be configured to control the greenhouse emission capturing device 108 to remove greenhouse emissions from the region surrounding the greenhouse emission capturing device 108, based on the received first load profile (such as, the received first load profile 302A of FIG. 3) associated with the factory 104 and the second load profile (such as, the received second load profile 304A of FIG. 3) associated with the power plant 106. Based on the received first load profile 302A (associated with the factory 104) and the second load profile 304A (associated with the power plant 106), the control circuitry 202 may determine a net amount of greenhouse emissions to be removed from the region surrounding the greenhouse emission capturing device 108. The greenhouse emission capturing device 108 may remove the net amount of greenhouse emissions from the region surrounding the greenhouse emission capturing device 108 in advance, prior to the generation of the same amount of greenhouse emissions by the factory 104 and/or the power plant 106. Details related to the control of the greenhouse emission capturing device are described further, for example, in FIG. 3 (at 306).

Although the flowchart 500 is illustrated as discrete operations, such as 504, 506, and 508 the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide non-transitory computer-readable medium having stored thereon. The computer-executable instructions may be executed by the system 102 may cause the system 102 to execute operations. The operations may include reception of a first load profile (such as, the first load profile 302A of FIG. 3) associated with a factory (such as, the factory 104 of FIG. 1). The operations may further include reception of a second load profile (such as, the second load profile 304A of FIG. 3) associated with a power plant (such as, the power plant 106 of FIG. 1), wherein the power plant 106 may be communicably coupled with the factory 104 and a greenhouse emission capturing device (such as, the greenhouse emission capturing device 108 of FIG. 1). The operations may further include controlling the greenhouse emission capturing device 108 to remove greenhouse emissions from a region surrounding the greenhouse emission capturing device 108, based on the received first load profile associated with the factory 104 and the second load profile associated with the power plant 106.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

What is claimed is:

1. A system, comprising:
control circuitry configured to:
receive a first load profile associated with a factory;
receive a second load profile associated with a power plant, wherein the power plant is communicably coupled with the factory and a greenhouse emission capturing device; and
control the greenhouse emission capturing device to remove greenhouse emissions from a region surrounding the greenhouse emission capturing device based on the received first load profile associated with the factory and the second load profile associated with the power plant.

2. The system according to claim 1, wherein the first load profile associated with the factory includes information indicative of at least one of an amount of power required by the factory, an amount of predicted greenhouse emission during an operation of the factory, or a first time period for which the power is required.

3. The system according to claim 1, wherein the second load profile associated with the power plant includes information indicative of at least one of an amount of power to be generated by the power plant, an amount of predicted greenhouse emission during an operation of the power plant, or a second time period for which the power is to be generated.

4. The system according to claim 1, wherein the control circuitry is further configured to determine a third time period for which the greenhouse emission capturing device is to be operated to remove the greenhouse emissions in the region surrounding the greenhouse emission capturing device, based on the received first load profile associated with the factory and the received second load profile associated with the power plant.

5. The system according to claim 4, wherein the control circuitry is further configured to determine a schedule for an operation of the greenhouse emission capturing device based on the determined third time period, and wherein
the control of the greenhouse emission capturing device is further based on the determined schedule.

6. The system according to claim 4, wherein the control circuitry is further configured to determine a fourth time period for which the greenhouse emission capturing device is to be kept under maintenance, and wherein
the third time period is determined further based on the fourth time period.

7. The system according to claim 1, wherein the control circuitry is further configured to receive a task schedule associated with the factory, wherein
the control of the greenhouse emission capturing device is further based on the received task schedule.

8. The system according to claim 1, wherein
the greenhouse emission capturing device is located within a first predefined distance from each of the factory and the power plant, and
the factory is located within a second predefined distance from the power plant.

9. A method, comprising:
in a system:
receiving a first load profile associated with a factory;
receiving a second load profile associated with a power plant, wherein the power plant is communicably coupled with the factory and a greenhouse emission capturing device; and
controlling the greenhouse emission capturing device to remove greenhouse emissions from a region surrounding the greenhouse emission capturing device based on the received first load profile associated with the factory and the second load profile associated with the power plant.

10. The method according to claim 9, wherein the first load profile associated with the factory includes information indicative of at least one of an amount of power required by the factory, an amount of predicted greenhouse emission during an operation of the factory, or a first time period for which the power is required.

11. The method according to claim 9, wherein the second load profile associated with the power plant includes information indicative of at least one of an amount of power to be generated by the power plant, an amount of predicted greenhouse emission during an operation of the power plant, or a second time period for which the power is to be generated.

12. The method according to claim 9, further comprising determining a third time period for which the greenhouse emission capturing device is to be operated to remove the greenhouse emissions in the region surrounding the greenhouse emission capturing device, based on the received first load profile associated with the factory and the received second load profile associated with the power plant.

13. The method according to claim 12, further comprising determining a schedule for an operation of the greenhouse emission capturing device based on the determined third time period, wherein
the control of the greenhouse emission capturing device is further based on the determined schedule.

14. The method according to claim 12, further comprising determining a fourth time period for which the greenhouse emission capturing device is to be kept under maintenance, wherein
the third time period is determined further based on the fourth time period.

15. The method according to claim 9, further comprising receiving a task schedule associated with the factory, wherein
the control of the greenhouse emission capturing device is further based on the received task schedule.

16. The method according to claim 9, wherein
the greenhouse emission capturing device is located within a first predefined distance from each of the factory and the power plant, and
the factory is located within a second predefined distance from the power plant.

17. A non-transitory computer-readable medium having stored thereon, computer-executable instructions that when executed by a system, causes the system to execute operations, the operations comprising:
receiving a first load profile associated with a factory;
receiving a second load profile associated with a power plant, wherein the power plant is communicably coupled with the factory and a greenhouse emission capturing device; and
controlling the greenhouse emission capturing device to remove greenhouse emissions from a region surrounding the greenhouse emission capturing device based on the received first load profile associated with the factory and the second load profile associated with the power plant.

18. The non-transitory computer-readable medium according to claim 17, wherein the first load profile associated with the factory includes information indicative of at least one of an amount of power required by the factory, an amount of predicted greenhouse emission during an operation of the factory, or a first time period for which the power is required.

19. The non-transitory computer-readable medium according to claim 17, wherein the second load profile associated with the power plant includes information indicative of at least one of an amount of power to be generated by the power plant, an amount of predicted greenhouse emission during an operation of the power plant, or a second time period for which the power is to be generated.

20. The non-transitory computer-readable medium according to claim 17, wherein the operations further comprise receiving a task schedule associated with the factory, wherein
the control of the greenhouse emission capturing device is further based on the received task schedule.
